(19) United States
(12) Patent Application Publication
(10) Pub. No.: US 2008/0224396 A1
(43) Pub. Date: Sep. 18, 2008

(54) JIGSAW EDUCATIONAL GAME

(76) Inventors: Florica Cocis, Queensland (AU); Vasile Cocis, Queensland (AU)

Correspondence Address: YOUNG & THOMPSON, 209 Madison Street, Suite 500, ALEXANDRIA, VA, 22314, US

(21) Appl. No.: 12/045,050

(22) Filed: Mar. 10, 2008

(30) Foreign Application Priority Data
Mar. 8, 2007 (AU) 2007100179

(51) Int. Cl. A63F 9/10; G09B 29/00

(52) U.S. Cl. 273/157 R; 434/130

(57) ABSTRACT

A Jigsaw educational game in one aspect therefore the invention resides in a jigsaw puzzle game comprising in combination, a plurality of jigsaw sheets or boards representing a geographical region e.g. continents or islands of the world; a plurality of jigsaw pieces for assembling on or in the jigsaw sheets or boards; question and answer means relating to the subject matter of the jigsaw sheets or boards and pieces, and rules for playing the jigsaw game wherein the winner is the first player to complete a jigsaw and has the right to earn further points by questioning the other players from the question and answer means, and wherein the rules further provide for the exchanging of jigsaw pieces between players to complete their individual jigsaws.

### FIELD OF THE INVENTION

This invention relates to educational games and playthings in particular but not limited to an educational jigsaw game to teach players geographical places, facts and figures.

### BACKGROUND ART

Jigsaw games are known prior art.

For example, U.S. Pat. No. 6,425,581 refers to an educational map puzzle game to teach children and adults to locate political entities in the world on a map. Puzzle pieces comprise of postage stamps, reproductions or simulated postage stamp reproductions corresponding to specific sites on large format continental and regional outlined maps.

JP2006217999 A2 discloses a jigsaw puzzle which has patterns displayed on surfaces of a base material and forms a global map that describes the topography of a country.

In particular, the puzzle consists of a deformed map chart prepared by using topographical maps in which topography maps of countries are arbitrarily selected from a world map together with the arranging of deformed maps of a plurality of countries expressed with deformed flags of the national flags of the countries.

In most of the prior art jigsaw based games, the main emphasis is on an entertainment rather than an educational basis. Educational content in the abovementioned prior art games is secondary and the games are generally limited to entertainment value or emphasis by the use of novel puzzle pieces such as representations of coins, stamps and national flags.

The use of novel puzzle pieces representing stamps, flags or otherwise also detracts from the general sovereign and territorial geographical information that should be the main or primary goal.

There is therefore a need for a simple educational jigsaw game based on geographical boundaries, typically continents or islands of the world incorporating and or including in combination a question and answer aspect for use by children or students of geography to improve their learning about the world.

### OBJECT OF THE INVENTION

It is therefore the object of the present invention to provide a novel and improved educational jigsaw game which overcomes the limitations of the prior art and to provide the public with an alternative and useful choice.

### STATEMENT OF THE INVENTION

In one aspect therefore the invention resides in a jigsaw puzzle game comprising in combination,

a plurality of jigsaw sheets or boards representing a geographical region e.g. continents or islands of the world;

a plurality of jigsaw pieces for assembling on or in the jigsaw sheets or boards;

question and answer means relating to the subject matter of the jigsaw sheets or boards and pieces, and

rules for playing the game wherein the winner is the first player to complete a jigsaw and has the right to earn further points by questioning the other players from the question and answer means, and wherein the rules further provide for the exchanging of jigsaw pieces between players to complete their individual jigsaws.

Preferably each jigsaw sheet or board represents a continent or an island of the world.

Preferably each jigsaw sheet or board representing a continent or an island of the world is colour coded such that jigsaw pieces comprising member states or territories of the island or continent are also colour coded with the same or related shade of colour.

Preferably the jigsaw sheets or boards are of a recessed configuration wherein the jigsaw pieces are inserted into the recesses of the jigsaw sheet or board.

Alternatively, the jigsaw sheets are configured as trays with a raised edging or circumferential border wherein the jigsaw pieces are assembled within the tray.

Preferably the jigsaw pieces are shaped to resemble the member states or territories of a country or continent and fit into complementary recesses in the jigsaw sheets.

Preferably the jigsaw sheets can be placed or joined adjacent to one another to form a complete map or representation of the world.

Preferably the question and answer means comprises one or more booklets with questions concerning facts and figures relating to the relevant jigsaw sheets or pieces and wherein preferably the answers to the questions are placed in another portion of the one or more booklets.

In the alternative, the question and answer means comprises question cards with the answers printed in the one or more booklets.

Preferably the rules of the game allow for the exchanging of the jigsaw pieces between players in one direction only, such as in a clockwise direction or a counter clockwise direction as well as the selection of further jigsaw pieces from a central pool.

Preferably the rules provide for the winner to be the player who first completes a jigsaw sheet and is therefore entitled to question the other players from the question and answer means.

Preferably the rules provide for correct answers to questions by the other players to be awarded points and the same points for incorrect answers to be awarded to the player asking the questions.

According to a further variation of the game, there can be included random selection means adapted to randomly select and assign or match jigsaw sheets or pieces to players or to determine the order of play between players.

Preferably the random selection means can include dice; roulette wheel devices or any mechanical or electronic means adapted to provide a selection or assignment based on chance.

### BRIEF DESCRIPTION OF THE DRAWINGS

In order that the invention be better understood and put into practical effect, reference will now be made to the accompanying drawings wherein:

FIG. 1 shows a preferred embodiment of the invention according to Example 1.

### DETAILED DESCRIPTION OF THE DRAWINGS

### Example 1

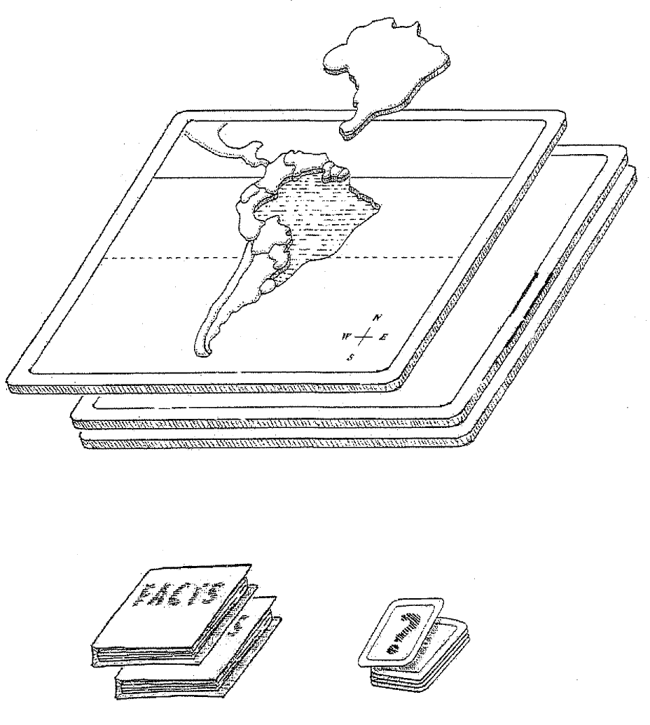

Referring to the specific embodiments and initially to FIG. 1 there is shown a map puzzle game 10 for teaching geography to children and adults consisting of a plurality of jigsaw puzzle sheets or boards 12, 14, 16. Each board preferably has a different coloured frame 12a, 14a, 16a or border for each continent 18 or island. The puzzle pieces 18a, 18b, 18c have printed continental features relevant to their particular sheet or board. There is preferably a set of question cards 20 for each continent or island and one or more informative booklets 24, 24 of answers to the question cards. The number of players can be any number between two (2) and preferably up to seven (7) players. The game is played in a clock wise (or counter clock wise) direction. The players make one move at a time. All the jigsaw pieces are emptied in the middle of the table facing down. Each player gets ten jigsaw puzzle pieces and starts to complete the continent of the jigsaw board assigned to them.

If a player does not have the right colour for his or her continent (e.g. navy blue frame will have light blue jigsaw puzzle pieces for completing the continent), then one has to place the unwanted piece on the right side of his or her board. That piece can be taken up only by the player to the right. If that player does not need that piece he or she will leave it there, and will take a new piece from the pool of pieces in the middle of the table. The first player who manages to complete the puzzle is the winner with 100 points and has the right to consult the booklet and ask five questions of the other players from the questionnaire cards. The players get 10 points for every correct answer, and for every incorrect answer 10 points will go to the winner. The player who did not have a chance to finish the board will take 10 points for each complete country or member state of the country or continent completed on his or her board. In the case that players run out of jigsaw puzzle pieces from the pool in the middle of the table, they will add all the pieces at the right of all the players to the pool to start again until someone completes a board.

Advantage

The present jigsaw game with the questionnaire cards gives one a sense of belonging to the world in which we live in through knowledge gathered visually from the puzzle and the information from the booklet. By learning more about places near or far away from us, children gain a greater self-esteem and it is very encouraging when they can locate the country, city, river, mountains in every day life when it comes up in discussion. The game gives a student the opportunity to seek and absorb basic information about a continent, country or territory represented on the various boards not only when the game is first played but during the future times it is played.

The invention improves academic and general knowledge with the help of the question cards which can be of gradually increasing difficulty whereby the game could be initially played by very young children e.g. from five years of age. From a beneficial aspect, players naturally grow in knowledge as the game is played repeatedly and questions of greater degrees of difficulty can be introduced. It can also be highly competitive wherein the greater the general knowledge of the player the higher the points that player can gain. There is undoubtedly great fun in knowing basic information about a continent or a country one has never visited. The interest of players to know more can also lead to research about a place or region or continent thereby spawning new hobbies based on travel. The game can be played by a family where every body from parents to children and even grandparents has something to learn about the world. It can improve a child's self esteem by obtaining improved marks in school, and even improve relationships with peers friends, teachers, siblings, parents etc through a common interest in people and places of the world.

### Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1. A Jigsaw educational game in one aspect therefore the invention resides in a jigsaw puzzle game comprising in combination,
a plurality of jigsaw sheets or boards representing a geographical region e.g. continents or islands of the world;
a plurality of jigsaw pieces for assembling on or in the jigsaw sheets or boards;
question and answer means relating to the subject matter of the jigsaw sheets or boards and pieces, and
rules for playing the jigsaw game wherein the winner is the first player to complete a jigsaw and has the right to earn further points by questioning the other players from the question and answer means, and wherein the rules further provide for the exchanging of jigsaw pieces between players to complete their individual jigsaws.

2. A jigsaw educational game as claimed in claim 1, wherein each jigsaw sheet or board represents a continent or an island of the world.

3. A jigsaw educational game as claimed in claim 2, wherein each jigsaw sheet or board representing a continent or an island of the world is colour coded and jigsaw pieces comprising member states or territories of the island or continent are also colour coded with the same or related shade of colour.

4. A jigsaw educational game as claimed in claim 1, wherein the jigsaw sheets or boards are of a recessed configuration wherein the jigsaw pieces are inserted into the recesses of the jigsaw sheet or board.

5. A jigsaw educational game as claimed in claim 4, wherein the jigsaw sheets are configured as trays with a raised edging or circumferential border wherein the jigsaw pieces are assembled within the tray.

6. A jigsaw educational game as claimed in claim 4, wherein the jigsaw pieces are shaped to resemble the member states or territories of a country or continent and fit into complementary recesses in the jigsaw sheets.

7. A jigsaw educational game as claimed in claim 1, wherein the jigsaw sheets can be placed or joined adjacent to one another to form a complete map or representation of the world.

8. A jigsaw educational game as claimed in claim 1, wherein the question and answer means comprises one or more booklets with questions concerning facts and figures relating to the relevant jigsaw sheets and wherein the answers to the questions are placed in another portion of the one or more booklets.

9. A jigsaw educational game as claimed in claim 1 wherein the question and answer means comprises question cards with the answers printed in a booklet(s).

10. A jigsaw educational game as claimed in claim 1, wherein the rules of the game allow for the exchanging of the jigsaw pieces between players in one direction only, such as a clockwise direction or a counter clockwise direction as well as the selection of further jigsaw pieces from a central pool.

11. A jigsaw educational game as claimed in claim 1, wherein the rules provide for the winner to be the player who first completes a jigsaw sheet and is therefore entitled to question the other players from the question and answer means.

12. A jigsaw educational game as claimed in claim 1, wherein the rules provide for correct answers to questions to be awarded points and the same points for incorrect answers to be awarded to the player asking the questions.

13. A jigsaw educational game as claimed in claim 1 there is included random selection means adapted to randomly select and assign or match jigsaw sheets or pieces to players or to determine the order of play between players.

14. A jigsaw educational game as claimed in claim 13, wherein the random selection means includes dice; roulette wheel devices or any mechanical or electronic means adapted to provide a selection or assignment based on chance.

15. (canceled)

16. A jigsaw educational game as claimed in claim 2, wherein the jigsaw sheets or boards are of a recessed configuration wherein the jigsaw pieces are inserted into the recesses of the jigsaw sheet or board.

17. A jigsaw educational game as claimed in claim 16, wherein the jigsaw sheets are configured as trays with a raised edging or circumferential border wherein the jigsaw pieces are assembled within the tray.

18. A jigsaw educational game as claimed in claim 16, wherein the jigsaw pieces are shaped to resemble the member states or territories of a country or continent and fit into complementary recesses in the jigsaw sheets.
